(19) United States
(12) Patent Application Publication
(10) Pub. No.: US 2013/0198777 A1
(43) Pub. Date: Aug. 1, 2013

(54) REPRODUCTION APPARATUS AND CONTROLLING METHOD USING THE SAME

(71) Applicant: SAMSUNG ELECTRONICS CO., LTD., Suwon-si (KR)

(72) Inventors: Hyung Suk KIM, Suwon-si (KR); Il-ki MIN, Anyang-si (KR)

(73) Assignee: SAMSUNG ELECTRONICS CO., LTD., Suwon-si (KR)

(21) Appl. No.: 13/743,680

(22) Filed: Jan. 17, 2013

(30) Foreign Application Priority Data
Jan. 31, 2012 (KR) 10-2012-0010065

(51) Int. Cl. H04N 21/81

(52) U.S. Cl. CPC H04N 21/8106
USPC 725/37; 725/131

(57) ABSTRACT

A method for controlling a reproduction apparatus is provided. The method for controlling a reproduction apparatus includes receiving contents including video data and audio data, transmitting a request for transmission of external audio data regarding the contents to an external server, and outputting the external audio data along with the video data in accordance with a user command for transmitting the external audio data.

### CROSS-REFERENCE TO RELATED APPLICATIONS

This application claims the benefit of Korean Patent Application No. 2012-0010065, filed in the Korean Intellectual Property Office on Jan. 31, 2012, the disclosure of which is incorporated herein by reference.

### BACKGROUND

1. Field

Aspects of embodiments relate to a reproduction apparatus and a controlling method thereof. More particularly, embodiments relate to a reproduction method which receives and outputs contents, and a controlling method using the same.

2. Description of the Related Art

Recently, users may view various contents while being provided with information regarding the contents. For example, users may receive various additional information, i.e., subtitles of contents or information regarding actors featured in the contents at the same time as viewing the contents.

However, users may not receive additional audio data other than audio data constituting the contents. In other words, a related art display apparatus outputs only video and audio, which constitutes the received contents, and does not provide additional audio data regarding the contents.

Accordingly, there is a need to meet the needs of users who wish to be provided with additional audio data.

### SUMMARY OF THE INVENTION

Aspects of the embodiments relate to a reproduction apparatus which is capable of receiving and outputting external audio data regarding contents and a controlling method thereof.

A method for controlling a reproduction apparatus according to an exemplary embodiment includes receiving contents including video data and audio data, transmitting a request for transmission of external audio regarding the contents to an external server, and in accordance with a user command, outputting the external audio data along with the video data.

The method may further comprise separating the video data and the audio data from the contents, and the outputting may include outputting the external audio data along with the separated video data.

The method may further include outputting a UI screen for requesting transmission of the external audio data to the external server.

The external server may be provided by at least one of a content manufacturer, a content service provider, and a content reproduction apparatus manufacturer.

The external audio data may be provided in a language different from a language of audio data in the contents.

A reproduction apparatus of contents including video data and audio data according to an exemplary embodiment includes a receiving unit which receives the contents, a communication interface unit which transmits a request for transmission of external audio regarding the contents to an external server, an output unit which outputs the received contents, and a control unit which, in accordance with a user command, outputs the external audio data along with the video data.

The apparatus may further include a signal processing unit which separates the video data and the audio data from the contents, and the control unit may stop outputting the external audio data separated from the contents and output the external audio data which is received in accordance with the transmission request along with the video data separated from the contents.

The control unit may control the output unit to output a UI screen for requesting transmission of the external audio data to the external server.

The external server may be provided by at least one of a content manufacturer, a content service provider, and a content reproduction apparatus manufacturer.

The external audio data may be provided in a language different from a language of audio data in the contents.

The output unit may include a display unit which processes and displays the video data as an image and a speaker which processes and outputs the audio data as audio.

According to the various exemplary embodiments, a user may be provided with external audio data regarding received contents.

### BRIEF DESCRIPTION OF THE DRAWINGS

These and other aspects and advantages of the embodiments will become apparent and more readily appreciated from the following description of the embodiments, taken in conjunction with the accompanying drawings, of which:

FIG. 1 is a view to explain a system for providing external audio data according to an exemplary embodiment;

FIG. 2 is a block diagram to explain configuration of a reproduction apparatus according to an exemplary embodiment;

FIG. 3 is a block diagram to explain detailed configuration of a reproduction apparatus according to an exemplary embodiment;

FIGS. 4A to 4C are views to explain a UI screen provided by a reproduction apparatus according to an exemplary embodiment; and

FIG. 5 is a flowchart to explain a method for controlling a reproduction apparatus according to an exemplary embodiment.

### DETAILED DESCRIPTION OF THE EMBODIMENTS

Reference will now be made in detail to the exemplary embodiments of the embodiments, examples of which are illustrated in the accompanying drawings. Like reference numerals refer to like elements throughout. The embodiments are described below, by referring to the figures.

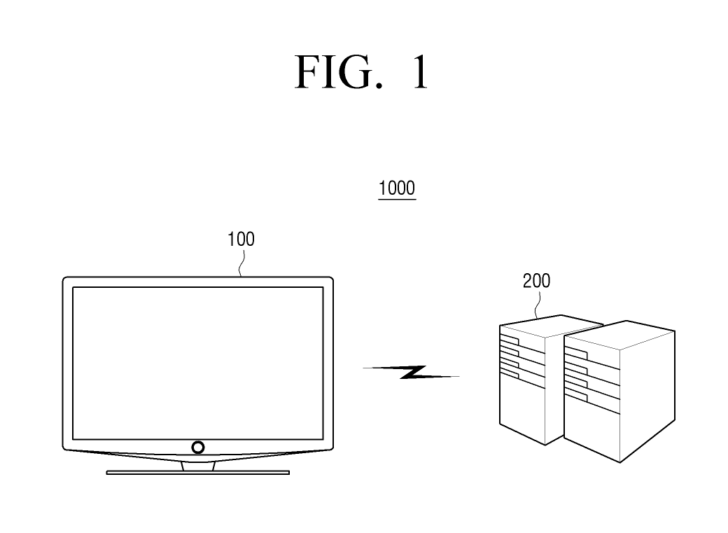

FIG. 1 is a view to explain a system for providing external audio data according to an exemplary embodiment. According to FIG. 1, a system 1000 comprises a reproduction apparatus 100 and a server 200.

The reproduction apparatus 100 receives and outputs contents including video data and audio data. Herein, the contents may be broadcast contents, Internet contents, Video On Demand (VoD) contents, etc.

The reproduction apparatus 100 may output a User Interface (UI) screen to request the server 200 to transmit external audio data corresponding to contents. In other words, the reproduction apparatus 100 may receive a user command to request the output of external audio data through a UI and transmit the command to request transmission of the external audio data to the server 200.

Accordingly, the reproduction apparatus 100 may receive external audio data regarding contents from the server 200 which is connected via a network and output the received external audio data along with video data constituting the contents. In other words, the reproduction apparatus 100 may receive audio data which is provided additionally with regard to contents from the server 200 and output the received audio data along with video data which is separated from the contents.

Herein, the audio data received from the server 200 may be realized as a different language from that of audio data constituting the contents. Accordingly, the reproduction apparatus 100 may provide a user with various audio data regarding contents.

The reproduction apparatus 100 which performs the above functions may be a television, but is not limited thereto. Any apparatus which is capable of receiving and display contents and is connected to the server 200 via a network, i.e., a smart television, a set-top box, a smart set-top box, a mobile terminal, a desktop PC, and a laptop PC may be the reproduction apparatus 100 according to an exemplary embodiment.

The server 200 may store external audio data corresponding to contents and provide the external audio data corresponding to contents to the reproduction apparatus 100 upon receiving a request from the reproduction apparatus 100. In other words, if the server 200 receives a transmission request command regarding external audio data from the reproduction apparatus 100, the server 200 may provide the external audio data to the reproduction apparatus 100.

Herein, the external audio data may be provided by one of a content manufacturer, a content service provider, and a content reproduction apparatus manufacturer. The external audio data may be updated periodically or upon a request from a provider.

The server 200 has external audio data by storing external audio data into a database and may provide the reproduction apparatus 100 with the external audio data by downloading or providing the external audio data in a streaming format. In some cases, the server 200 may be configured such that it receives external audio data and transmits the external audio data to the reproduction apparatus 100 by communicating with a separate content providing server (not shown).

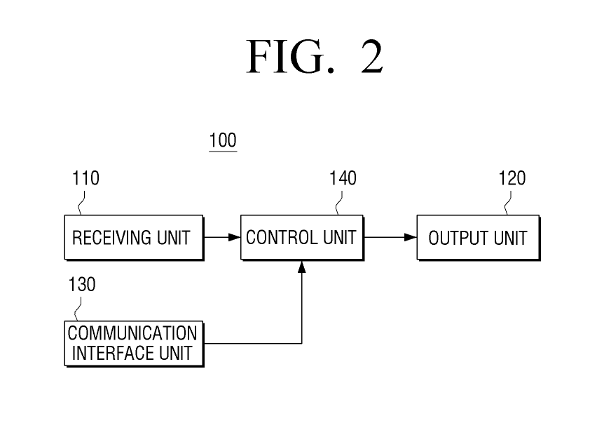

FIG. 2 is a block diagram to explain configuration of a reproduction apparatus according to an exemplary embodiment. According to FIG. 2, the reproduction apparatus 100 includes a receiving unit 110, an output unit 120, a communication interface unit 130, and a control unit 140.

The receiving unit 110 receives contents including video data and audio data.

Specifically, the receiving unit 110 receives contents from a broadcasting station, which transmits a broadcast content using a broadcasting network, or from a web server, which transmits a content file via Internet. The receiving unit 110 may be formed in the reproduction apparatus 100 or may receive contents from various recording medium reproduction apparatuses connected to the reproduction apparatus 100. The recording medium reproduction apparatus represents an apparatus which reproduces contents stored in various types of recording media, i.e., a CD, a DVD, a hard disk, a Blu-ray disk, a memory card, and a USB memory.

In an exemplary embodiment, where contents are received from a broadcasting station, the receiving unit 110 may be configured to include such components as a tuner (not shown), a demodulator (not shown), and an equalizer (not shown). On the other hand, in an exemplary embodiment where contents are received from a source such as a web server, the receiving unit 110 may be realized as a network interface card (not shown). Alternatively, in an exemplary embodiment where contents are received from various recording medium reproduction apparatus, the receiving unit 110 may be realized as an interface (not shown) connected to the recording medium reproduction apparatus.

Therefore, the receiving unit 110 may be realized as various forms according to exemplary embodiments to receive broadcast contents, Internet contents, VOD contents, etc.

The output unit 120 outputs received contents. Specifically, the output unit 120 may be configured to include a display unit (not shown) and a speaker (not shown). The output unit 120 may synchronize and output audio data and video data constituting contents.

The communication interface unit 130 transmits a request for transmission of external audio data regarding contents to an external server (not shown). The communication interface unit 130 may receive the external audio data from the external server in response to a transmission request.

Herein, the external audio data may be realized as a different language than the audio data of the contents. For example, if the contents received from the reproduction apparatus 100 are in Korean, an external server may provide audio data in English to the reproduction apparatus 100. Alternatively, if the contents received from the reproduction apparatus 100 are in English, an external server may provide audio data in Korean to the reproduction apparatus 100.

Meanwhile, the communication interface unit 130 may be connected to an external server through various methods to request transmission of external audio data and receive the audio data from the external server.

For example, the communication interface unit 130 may comprise a wired communication port, i.e., a network interface card (not shown) or a wireless communication module supporting a communication network, i.e., a 3G network and a WiFi-network to be connected to an external server to receive audio data. In addition, the communication interface unit 130 may be realized as a tuner (not shown) and receive audio data from an external server using an Radio Frequency (RF) method.

In the above exemplary embodiment, the communication interface unit 130 receives external audio data. However, this is only an example. In other words, the communication interface unit 130 may receive contents and external audio data corresponding to the contents from an external server.

The control unit 140 controls overall operations of the reproduction apparatus 100. For example, the control unit 140 may receive various contents through the receiving unit 110, convert the received contents into contents which can be output, and output them using the output unit 120. The control unit 140 may control the interface unit 130 to transmit a request for transmission of external audio data to an external server and receive the external audio data from the eternal server.

Meanwhile, the control unit 140 may control the output unit 120 to output a UI for requesting transmission of external audio data. In other words, the control unit 140 may provide a UI for requesting transmission of external audio data to a user and receive a command to transmit the external audio data from the user.

The information regarding whether contents include an external audio data may be included in the contents, or may be received from an external server.

For example, suppose that the information regarding whether external audio data is included or not is included in the contents received from the receiving unit 110. In this case, if a command to request transmission of external audio data is input from a user, the control unit 140 may transmit contents information, i.e., a content title, a content ID, etc. to an external server through the communication interface unit 130 and receive audio data corresponding to the contents from the external server.

In another exemplary embodiment, suppose that the information regarding whether external audio data is included or not is not included in the contents received from the receiving unit 110. If a command to request transmission of external audio data is input from a user, the control unit 140 may transmit a message asking whether there is additional audio data regarding the received contents to an external server through the communication interface unit 130.

In this case, the control unit 140 may determine whether there is audio data corresponding to the contents in an external server by transmitting contents information a content title, a content ID, etc. to the external server. If it is determined that there is audio data corresponding to the contents, the external server transmits the audio data to the reproduction apparatus 100. However, if it is determined that there is no audio data corresponding to the contents, the external server may transmit information that there is no audio data corresponding to the contents to the reproduction apparatus 100. Upon receiving the information that there is no audio data corresponding to the contents from an external server, the control unit 140 may output a UI for notifying the information through the output unit 120.

In addition, the control unit 140 may control the output unit 120 to output external audio data along with video data based on a user command.

Specifically, if a user command to output external audio data is input, the control unit 140 may output external audio data together with video data which is separated from contents. In other words, the control unit 140 may stop outputting audio data constituting the contents received through the receiving unit 110 and output external audio data along with video data constituting the contents. In this case, the control unit 140 may control the output unit 120 to synchronize the video data with the external audio data.

Therefore, the control unit 140 may replace audio data which has been provided with audio data received from an external server. Accordingly, users may be provided with contents in various languages.

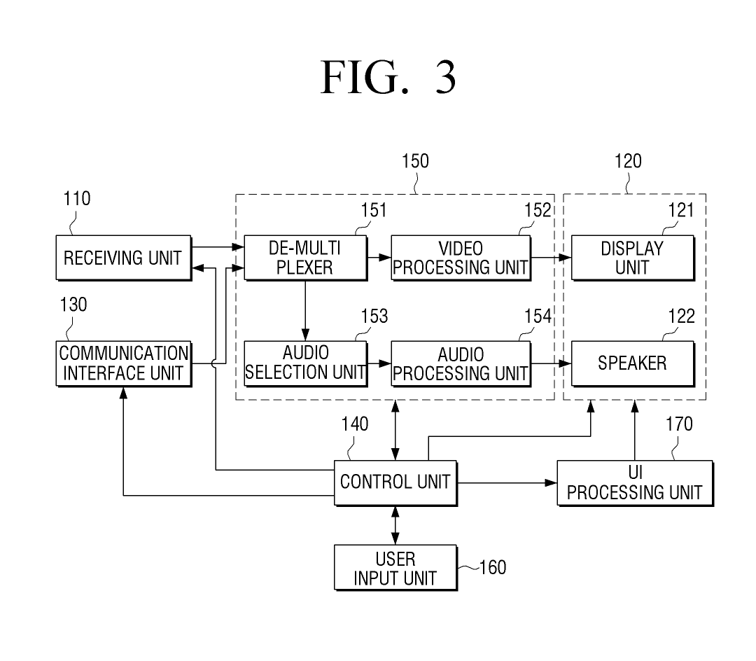

FIG. 3 is a block diagram to explain detailed configuration of a reproduction apparatus according to an exemplary embodiment. According to FIG. 3, the reproduction apparatus 100 comprises the receiving unit 110, the output unit 120, the communication interface unit 130, the control unit 140, a signal processing unit 150, a user input unit 160, and a UI processing unit 170. The elements in FIG. 3 which have like reference numerals as those in FIG. 2 perform like functions as those in FIG. 2. Thus, further description will not be provided.

The receiving unit 110 receives contents including video data and audio data. Herein, the contents may be broadcast contents, Internet contents, VOD contents, etc.

The communication interface unit 130 may transmit a request for transmission of external audio data regarding contents to an external server (not shown) and receive the external audio data from the external server.

The signal processing unit 150 separates video data and audio data from contents. The signal processing unit 150 comprises a de-multiplexer 151, a video processing unit 152, an audio selection unit 153, and an audio processing unit 154. Operation of each element can be controlled by the control unit 140.

The de-multiplexer 151 receives contents from the receiving unit 110 and receives external audio data from the communication interface unit 130. The de-multiplexer 151 may separate video data and audio data from the contents received from the receiving unit 110 and remove noise of the separated audio data and external audio data using a filter (not shown).

The video processing unit 152 performs signal-processing with respect to the video data received from the de-multiplexer 151. Specifically, the video processing unit 152 performs signal-processing such as decoding, scaling, and frame-rate conversion with respect to the video data. Thus, the video data can be output from the video output unit 121.

The audio selection unit 153 selects one of audio data separated from contents and external audio data. Specifically, the audio selection unit 153 may output audio data constituting contents to the audio processing unit 154 until a user command is input. If a user command is input to output external audio data, the audio selection unit 153 may output the external audio data to the audio processing unit 154.

The audio processing unit 154 performs signal-processing with respect to audio data received from the audio selection unit 153. For example, the audio processing unit 154 may perform signal-processing, i.e., decoding with respect to audio data separated from contents or external audio data and output the processed data to the audio output unit 122.

The output unit 120 comprises a display unit 121 and a speaker 122 and may provide contents to a user.

Specifically, the display unit 121 may process video data to display the data as an image. The display unit 121 may be realized as a Liquid Crystal Display (LCD), an Organic Light Emitting Display (OLED), or a Plasma Display Panel (PDP).

Meanwhile, the speaker 122 may process audio data to output the data as audio. Specifically, the speaker 122 may amplify audio data received from the audio processing unit 154 and provide the amplified audio data to a user. Although audio is output through the speaker 122 in the exemplary embodiment, an output port, i.e., a jack may also be provided.

Meanwhile, the display unit 121 and the speaker 122 may synchronize and output audio data and video data constituting contents under the control of the control unit 140.

The user input unit 160 is an element which receives various user commands. Specifically, the user input unit 160 may receive a user command to transmit external audio data by a keypad in the main body of a reproduction apparatus. The user input unit 160 may be an element which receives a signal to request transmission of external audio data by a key in an external remote controller. In addition, the user input unit 160 may receive a user command to output the received external audio data.

The user input unit 160 may be realized as a touch screen. If a UI for requesting transmission of external audio data is displayed on the screen of a reproduction apparatus and the UI is touched, the user input unit 160 may recognize it as a request for transmission of external audio data is input.

The UI processing unit 170 may generate various UIs output from the output unit 120. Herein, the UI processing unit 170 may generate UIs in a 2D or 3D format.

In particular, the UI processing unit 170 may generate a UI for requesting transmission of external audio data regarding contents, a UI for notifying information that there is no external audio data in an external server, a UI for receiving a command to output received external audio data, etc. under the control of the control unit 140.

In addition, the UI processing unit 170 may generate a main menu, a sub menu, etc. on a display screen in an OSD format as a user manipulates input apparatuses such as a manipulation panel or a remote controller to select desired menus. Such menus may include option items selectable by the reproduction apparatus 100 or items for controlling the functions of the reproduction apparatus 100.

The control unit 140 controls the operations of the receiving unit 110, the output unit 120, the communication interface unit 130, the control unit 140, the signal processing unit 150, the user input unit 160 and the UI processing unit 170 which constitute the reproduction apparatus 100. These elements have already been described above, so further description will not be provided.

In particular, the control unit 140 may control the output unit 120 to output a UI for requesting transmission of external audio data. In addition, if a command to request transmission of external data is input from a user through a UI screen, the control unit 140 may control the communication interface unit 130 to transmit the request for transmission of external audio data to an external server.

The control unit 140 may control the output unit 120 to output external audio data along with video data in accordance with a user command. Specifically, if a user command to output external audio data is input, the control unit 140 may output external audio data received through the communication interface unit 130 along with video data which is separated from contents.

The control unit 140 controls the output unit 120 to display a UI screen for receiving a command to output the received external audio data. If a user command is input through the UI screen, the control unit 140 may output the external audio data together with video data.

In the exemplary embodiment, external audio data is output along with video data separated from contents when a user command to output the received external audio data is input. However, this is only an example.

Therefore, if external audio data is received form an external server in accordance with a transmission request, the control unit 140 may output the received external audio data together with video data separated from contents without a user command. In other words, a request for transmission of external audio data may be interpreted as a user command to output the external audio data.

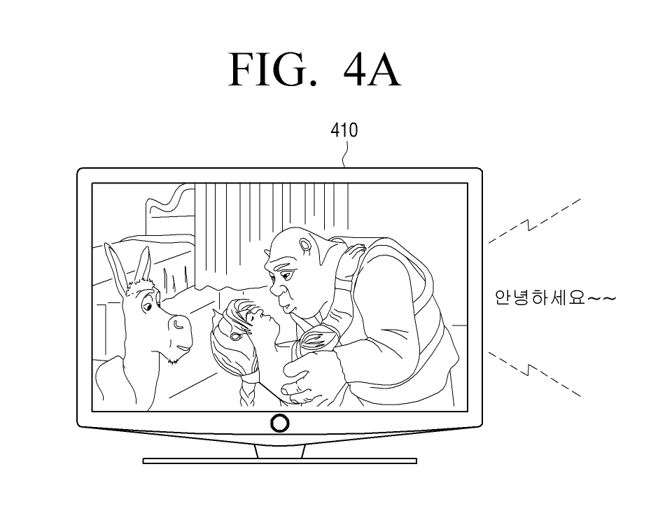

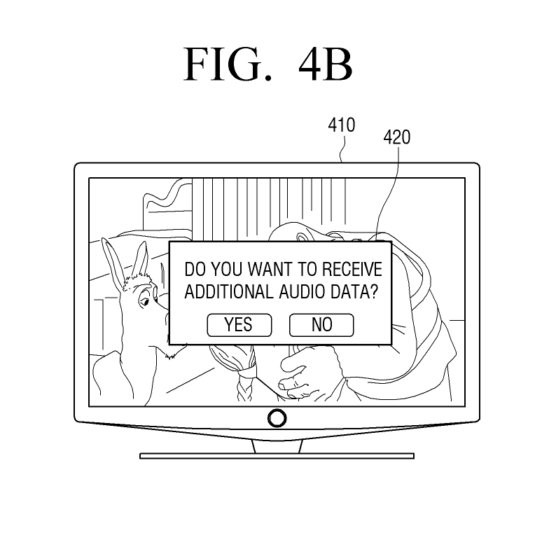

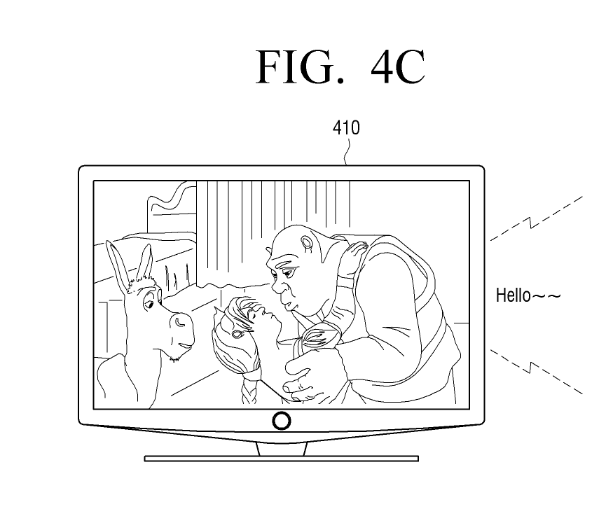

FIGS. 4A to 4C are views to explain a UI screen provided by a reproduction apparatus according to an exemplary embodiment

First of all, a reproduction apparatus 410 outputs video data and audio data. The outputted video data and audio data are separated from received contents. For example, as illustrated in FIG. 4A, the reproduction apparatus 410 may output audio data in Korean.

Meanwhile, the reproduction apparatus 410 may output a UI to request for transmission of external audio data. For example, as illustrated in FIG. 4B, if a user command to output external audio data is input, a UI 420 for asking whether external audio data is received may be output.

In the above exemplary embodiment, if a user command to output external audio data is input, a UI for requesting transmission of external audio data is input. However, this is only an example. If a user selects specific contents, the reproduction apparatus 410 may output a UI to request for transmission of external audio data automatically. For example, if the reproduction apparatus 410 receives broadcast contents, a specific channel is selected in accordance with a command to change channels. Subsequently, contents received from the selected channel and a UI for requesting transmission of external audio data may be output simultaneously.

If a request for transmission of external audio data is input from a user through a UI for requesting transmission of the external audio data, the reproduction apparatus 410 may transmit the transmission request to an external server (not shown), receive the external audio data from the external server, and output it. For example, if a user command to output received external audio data is input as illustrated in FIG. 4C, the reproduction apparatus 410 may stop outputting audio data in Korean, which is separated from contents and synchronize and output the external audio data in English along with video data included in the contents. Accordingly, a user may be provided with the contents in various languages.

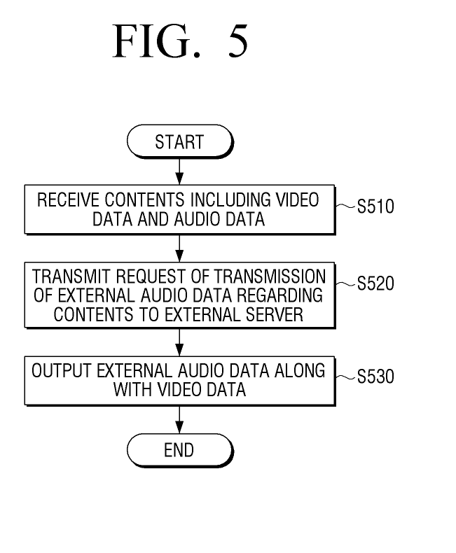

FIG. 5 is a flowchart to explain a method for controlling a reproduction apparatus according to an exemplary embodiment.

First, contents including video data and audio data are received (S510). Herein, the contents may be broadcast contents, Internet contents, VOD contents, etc.

Subsequently, a request for transmission of external audio data regarding the contents is transmitted to an external server (S520). Herein, the external server may be provided by at least one of a content manufacturer, a content service provider, and a content reproduction apparatus manufacturer. The external audio data may be provided in a language different from that of audio data in the contents.

Specifically, a UI screen for requesting transmission of external audio data to the external server is output. If a user command to request the output of external audio data is input through the UI, a request for transmission of the external audio data may be transmitted to the external server.

In accordance with a user command, the external audio data is output along with the video data (S530). Specifically, video data and audio data are separated from the contents, and the output of the audio data separated from the contents is stopped and the external audio data received in accordance with the transmission request may be output together with the video data separated from the contents.

Specifically, a program code for performing the above-mentioned methods may be stored in various types of recording medium readable by a terminal, such as Random Access Memory (RAM), flash memory, Read Only Memory (ROM), Erasable Programmable ROM (EPROM), Electronically Erasable and Programmable ROM (EEPROM), register, HDD, removable disk, memory card, USB memory, and CD-ROM.

Although a few embodiments have been shown and described, it would be appreciated by those skilled in the art that changes may be made in this embodiment without departing from the principles and spirit of the embodiments, the scope of which is defined in the claims and their equivalents.

What is claimed is:

1. A method for controlling a reproduction apparatus, comprising:
receiving contents including video data and audio data;
transmitting a request for transmission of external audio data regarding the contents to an external server; and
outputting the external audio data along with the video data in accordance with a user command for transmitting the external audio data.

2. The method as claimed in claim 1, further comprising:
separating the video data and the audio data from the contents, wherein the outputting comprises outputting the external audio data along with the separated video data.

3. The method as claimed in claim 1, further comprising:
outputting a UI screen for requesting transmission of the external audio data to the external server.

4. The method as claimed in claim 1, wherein the external server is provided by at least one of a content manufacturer, a content service provider, and a content reproduction apparatus manufacturer.

5. The method as claimed in claim 1, wherein the external audio data is provided in a language different from a language of audio data in the contents.

6. A reproduction apparatus of contents including video data and audio data, the apparatus comprising:
a receiving unit which receives the contents;
a communication interface unit which transmits a request for transmission of external audio data regarding the contents to an external server. an output unit which outputs the received contents; and
a control unit which, in accordance with a user command for transmitting the external audio data, outputs the external audio data along with the video data.

7. The apparatus as claimed in claim 6, further comprising:
a signal processing unit which separates the video data and the audio data from the contents,
wherein the control unit stops outputting the audio data separated from the contents and outputs the external audio data, which is received in accordance with the transmission request, along with the video data separated from the contents.

8. The apparatus as claimed in claim 6, wherein the control unit controls the output unit to output a UI screen for requesting transmission of the external audio data to the external server.

9. The apparatus as claimed in claim 6, wherein the external server is provided by at least one of a content manufacturer, a content service provider, and a content reproduction apparatus manufacturer.

10. The apparatus as claimed in claim 6, wherein the external audio data is provided in a language different from a language of audio data in the contents.

11. The apparatus as claimed in claim 6, wherein the output unit comprises:
a display unit which processes and displays the video data as an image; and
a speaker which processes and outputs the audio data as audio.

12. A reproduction apparatus of contents including video data and internal audio data, the apparatus comprising:
a receiving unit which receives the contents including video data and internal audio data;
a user interface (UI) processing unit which generates a UI for requesting transmission of external audio data regarding contents;
a communication interface unit which transmits the generated UI for requesting transmission of external audio data regarding the contents to an external server;
an output unit which outputs the received contents to a user;
a user input which receives user commands; and
a control unit which, in accordance with the user commands, outputs the external audio data along with the video data.

13. The apparatus as claimed in claim 12, further comprising:
a signal processing unit which separates the video data and the internal audio data from the contents, wherein the control unit stops outputting the internal audio data separated from the contents and outputs the external audio data, which is received in accordance with the transmission request, along with the video data separated from the contents.

14. The apparatus as claimed in claim 12, wherein the control unit controls the output unit to output the UI for requesting transmission of external audio data regarding contents to the external server.

15. The apparatus as claimed in claim 12, wherein the external server is provided by at least one of a content manufacturer, a content service provider, and a content reproduction apparatus manufacturer.

16. The apparatus as claimed in claim 12, wherein the external audio data is provided in a language different from a language of the internal audio data.

17. The apparatus as claimed in claim 12, wherein the output unit comprises:
a display unit which processes and displays the video data as an image; and
a speaker which processes and outputs the audio data as audio.

18. The apparatus as claimed in claim 12, wherein the signal processing unit comprises:
a de-multiplexer which receives the contents from the receiving unit and external audio data from the communication interface unit, separates video data and internal audio data from the received contents, and removes noise of the separated internal audio data and the external audio data using a filter;
a video processing unit which receives the separated video data from the de-multiplexer, and performs decoding, scaling, and frame-rate conversion with respect to the received separated video data;
an audio selection unit which selects one of separated internal audio data and the external audio data; and
an audio processing unit with receives the selected audio data, performs decoding with respect to the selected audio data, and outputs the decoded audio data to the output unit.
